(19) United States
(12) Patent Application Publication
(10) Pub. No.: US 2008/0314893 A1
(43) Pub. Date: Dec. 25, 2008

(54) HEATING DEVICE WITH ADJUSTING ELECTRICAL CONTACT

(76) Inventors: Joel E. Adair, Racine, WI (US); Sebastian D. Hasik, Antioch, IL (US); John T. Filiczkowski, Spring Grove, IL (US)

Correspondence Address: S.C. JOHNSON & SON, INC., 1525 HOWE STREET, RACINE, WI, 53403-2236, US

(21) Appl. No.: 11/767,979

(22) Filed: Jun. 25, 2007

(51) Int. Cl. H05B 1/00

(52) U.S. Cl. 219/483

(57) ABSTRACT

An electrical heating device is disclosed that is suitable to vaporize air treatment chemicals from an impregnated substrate. The device is provided with a PCT heater held between electrical contacts and a spring that is compressed between the housing of the heating device and one of the electrical contacts to maintain pressure thereon in spite of thermal expansion of the housing, ensuring good electrical contact between the PCT heater and the electrical contacts.

### CROSS-REFERENCE TO RELATED APPLICATIONS

Not applicable.

### STATEMENT REGARDING FEDERALLY SPONSORED RESEARCH/DEVELOPMENT

Not applicable.

### BACKGROUND OF THE INVENTION

The present invention relates to heaters, such as positive temperature coefficient (PTC) heaters, used to vaporize air treatment chemicals from a substrate. More particularly it relates to spring assemblies which can adjust for thermal expansion of such heaters.

Electrical heaters have been developed to heat a substrate (e.g. a mat) impregnated with an air treatment chemical, to thereby dispense the chemical. For example WO 2006/046209 (the disclosure of which is hereby incorporated by reference as if fully set forth herein) discloses one such PTC electrical heater. Also representative of the current state of the art are U.S. Pat. Nos. 4,404,463, 4,431,983, 4,728,779, 4,874,924, 5,256,857 and 5,471,034, and also WO 97/02054.

However, devices of this type do have some drawbacks. For one thing, the outer housings of such PTC heaters tend to undergo thermal expansion during operation. As most of the electrical components are anchored to the housing, this can cause relative movement of the electrical parts with respect to each other, thereby disrupting electrical contact, or rendering heat transfer less efficient.

To adjust for this to some extent there have been attempts to incorporate springs into the assembly. One approach is to make a portion of the electrical contact itself into an integral spring-like structure. However, this can increase production costs or complexity, or be difficult to reliably implement if one also wishes to use optimal electrical contact materials.

There have also been attempts to instead use separate springs which bias an electrical contact against a heater, yet allow some relative movement. However, to date, these assemblies have had their own deficiencies (e.g. complexity; cost; inability to adjust for certain types of expansion).

Apart from this, PTC heater elements are sometimes so fragile that their abutment with associated electrical contacts (particularly those that are stamped) can lead to breakage of the PTC element. A stamped contact can have a sharp edge which, over time, can lead to such cracking. While there have been attempts to avoid the use of stamped contacts with sharp ends (e.g. our company's U.S. Ser. No. 11/614,645 filed on Dec. 21, 2006), materials which are optimal for that purpose may not be optimal for certain spring related functions.

Hence, a need still exists for improved electrical heaters useful for vaporizing air treatment chemicals.

### BRIEF SUMMARY OF THE INVENTION

In one aspect the invention provides a heating device having a housing defining an internal cavity and having spaced supports extending there from into the cavity, a heating element positioned in the cavity, a first electrical contact abutting the heating element along a first side of the heating element, a second electrical contact abutting the heating element on a side thereof opposite the first side, and a spring suspended by the spaced supports and having a portion thereof biasing the second electrical contact towards the heater element.

The spring has a convex surface pointed away from the second electrical contact and rising sufficiently there from so as to be pressed against the interior surface of the housing. As a result, the convex portion of the spring is compressed and remaining parts of the spring apply pressure against the second electrical contact, securing it against the heating element. The spring is sufficiently compressed that, even as the housing expands when heated, the spring remains in contact with the housing and continues to apply pressure against the second electrical contact. As a result, the second electrical contact remains properly engaged against the heating element, and the heating element, in turn, is also urged against the first electrical contact, ensuring uninterrupted electrical connections.

In preferred forms the heating element is a pill-shaped positive temperature coefficient heating element, the spring has a convex surface pointed away from the second electrical contact and a concave surface pointed towards the second electrical contact, and the first electrical contact has a contact head that bulges towards the heating element. The first electrical contact may also serve a heat diffusion function.

Our heaters are intended to be used with a substrate positioned against an outside surface of the housing, the substrate bearing a volatilizable air treatment chemical such as an insect control active ingredient, a scent, a deodorizer, or the like. Heating causes the chemical to volatize from the mat, thereby treating the room air.

For example, in one preferred embodiment the heater could be used with a conventional mosquito control mat formed of compressed cellulosic fibers that have been impregnated with an insect control agent such as allethrin or metofluthrin. The art is well aware of a number of other substrates, and other air treatment chemicals, that can be used with these types of devices (e.g. repellents, fragrances, deodorizers).

Our devices therefore accommodate thermal expansion, without imposing undesirable design constraints on the electrical contacts. Further, our devices can be inexpensively produced, which may be particularly important to their commercial potential in some third world markets.

The foregoing and other advantages of the present invention will become apparent from the following description. In that description reference is made to the accompanying drawings which form a part thereof, and in which there is shown by way of non-limiting illustration a preferred embodiment of the invention. The claims which follow thereafter should be looked to in order to judge the full scope of the invention.

### BRIEF DESCRIPTION OF THE DRAWINGS

FIG. 1 is a perspective view of an embodiment of the invention, shown with an impregnated mat about to be installed therein;

FIG. 2 is an exploded perspective view of the FIG. 1 embodiment, albeit without the impregnated mat shown;

FIG. 3 is an exploded perspective view of a PTC heater portion of the FIG. 1 device;

FIG. 4 is another exploded perspective view of the PTC heater of FIG. 3;

FIG. 5 is a perspective view of part of the PTC heater of FIG. 4, but showing how alternate forms of the preferred spring could instead be used;

FIG. 6 is a cross-sectional view taken along line 4-4 of FIG. 1; and

FIG. 7 is a cross-sectional view taken along line 7-7 of FIG. 6.

### DETAILED DESCRIPTION OF THE PREFERRED EMBODIMENTS

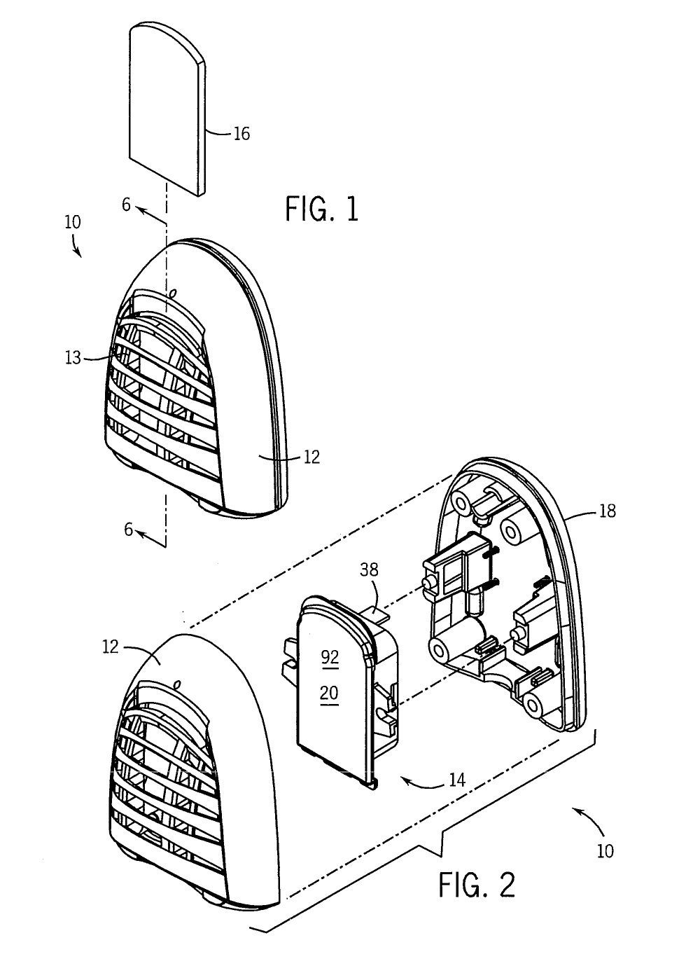

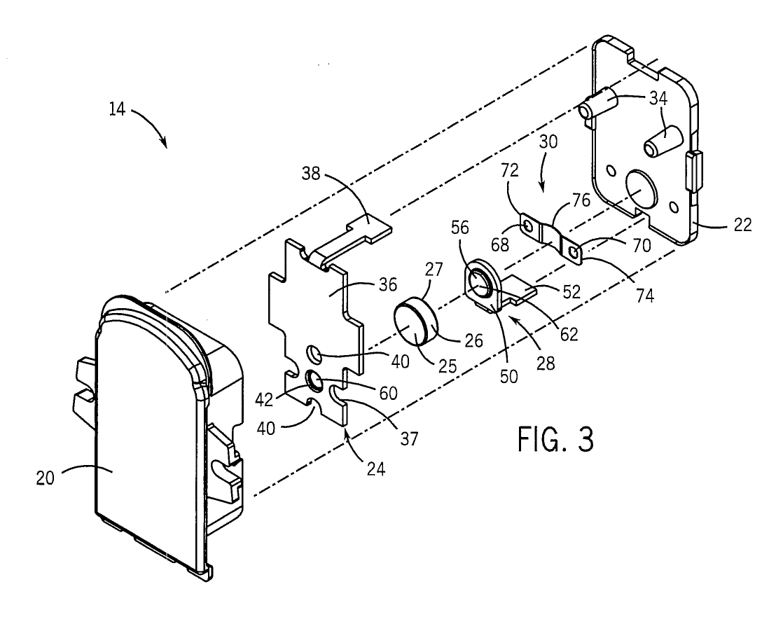

Referring first to FIGS. 1-2 and 6-7, there is shown a vaporizer 10 which includes a cover 12 having a air grill 13, a PTC heater 14, an impregnated mat 16, and a housing bottom 18. As will be apparent from FIG. 3, PTC heater 14 includes a first housing part 20, a second housing part 22, a first electrical contact 24, a PTC pill form heating element 26, a second electrical contact 28, and most importantly spring 30. The first housing part 20 supports the first electrical contact 24, which abuts a second side 25 of the PTC heating element 26. The second electrical contact 28 abuts a side 27 of the PTC heating element 26 opposite the side abutting the first electrical contact 24.

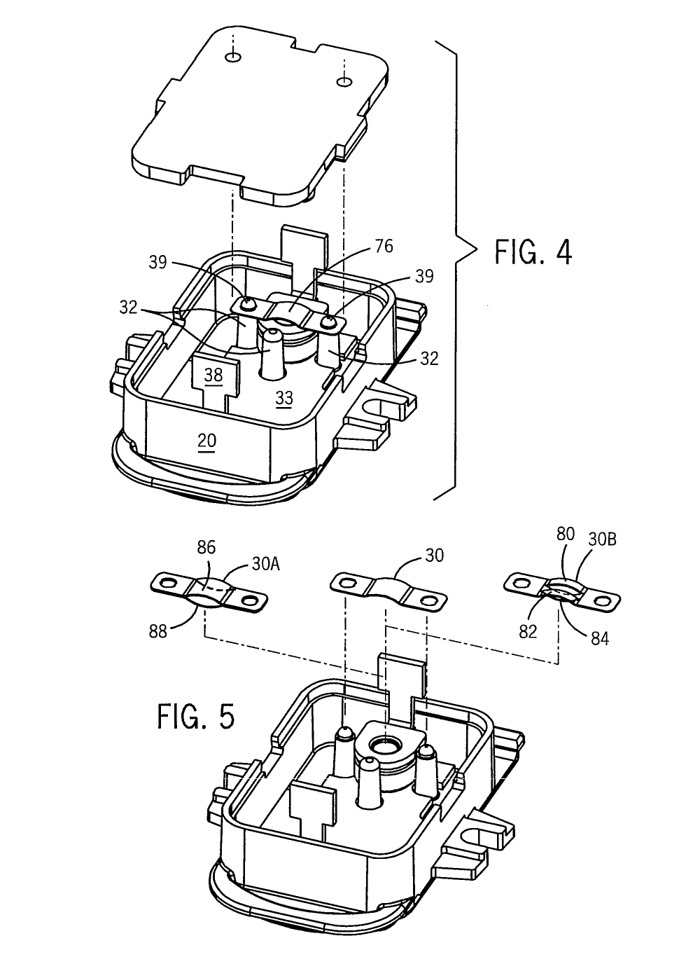

As shown in FIGS. 3 and 4, the first housing part 20 and second housing part 22 form a clamshell type housing to define a cavity 33 there between. First housing part 20 has support pegs 32 integrally formed therewith and extending into the cavity 33. These pass the first electrical contact 24 by virtue of cut outs 37. The ends of the spring 30 can be pinned or otherwise fastened to the support pegs 32 spanning the distance between them.

The second housing part 22 also has pegs 34 protruding inwards towards the first housing part 20. These pegs 34 help fix the first electrical contact 24 in place when the housing is closed.

The first electrical contact 24 preferably comprises a flat heat diffuser plate section 36 linked by a right angle bend to an elongated leg 38. The leg 38 forms one terminal of a linkage to the power supply, and thus after assembly extends outside the housing. There are also apertures 40 for receiving additional pegs 32 from the first housing part 20.

The PTC heating element 26 includes a first side 27 and a second side 25. While heating element 26 is shown in a “pill” form, other conventional PTC element shapes could also be used. Further, heating element 26 can have metallization on either or both sides (not shown).

The second electrical contact 28 preferably comprises a U-shaped plate 50 including an elongated leg 52 extending away from the plate 50 at a right angle. Elongated leg 52 forms the second terminal of a linkage to the power supply and ultimately remains extending outside the housing. There is also a curved dome having a contact portion 56. The dome can have a convex side 62.

A spring 30 is in the form of a stainless steel strip having apertures 68, 70 in opposing ends 72, 74. The apertures 68, 70 receive the tapered ends 39 of pegs 32 in wedging fashion, to thereby suspend the spring 30 over and against second electrical contact 28. The middle suspended portion 76 of the spring 30 is convex in shape (i.e., bulges outwardly, away from the second electrical contact 28).

While stainless steel is an optimal metal for the spring in this environment, it is not optimal for the second electrical contact 28. For that we prefer a metal such as aluminum.

Referring most specifically to FIG. 5, alternate spring embodiments 30A and 30B of the spring 30 are shown. For spring 30A two of the spring 30 elements are attached to each other face-to-face to create a convex bulge 86 and a concave bulge 88. In spring 30B the middle portion of a single spring 30 is split lengthwise, leaving three thinner strips 80, 82 and 84. Strips 80 and 82 are convex (curving away from the second electrical contact 28), while the middle strip 84 is concave in shape (curving toward the second electrical contact).

The convex portion 76 of the spring 30 presses against the interior side of the second housing part 22 when the housing is assembled, somewhat compressing the convex portion of the spring. The convex portion 76 is sufficiently compressed that, when the housing expands in response to the heating of the heating element 26, the convex portion rebounds to cause the spring 30 to remain in contact with the second housing part 22 and to continue to apply pressure against the second electrical contact 28. The convex portions 80 and 82 of alternative embodiment spring 30B and 86 of alternative embodiment spring 30B function in that same way. Thus, regardless of the spring embodiment 30,30A,30B used, the spring helps maintain a positive pressure contact between the second electrical contact 28 and the PTC heating element 26, and thus indirectly between the first electrical contact 24 and the PTC heating element, even during thermal expansion of the housing. In fact, because the spring 30 receives heat directly from the heating element 26 by conduction through the second electrical contact 28, the spring tends to expand to an extent proportionally greater than the expansion of the housing, which tends to urge the convex portion of the spring even more securely against the housing. The combination of convex and concave portions of alternative spring embodiments 30A and 30B allows those curved parts to be compressed so as to achieve the same overall displacement as is achieved by compression of the convex portion of spring 30 but with less distortion of each individual curved part.

Note also that because the parts are held close together, heat can readily transfer from the pill form heating element 26 to the heat diffusing plate portion of the first electrical contact 24. Thus, the process of transferring heat to an outer surface 92 of the PTC heater remains efficient even during thermal expansion. Note that the thermal expansion problem occurs even if preferred plastics are used for the outer housing.

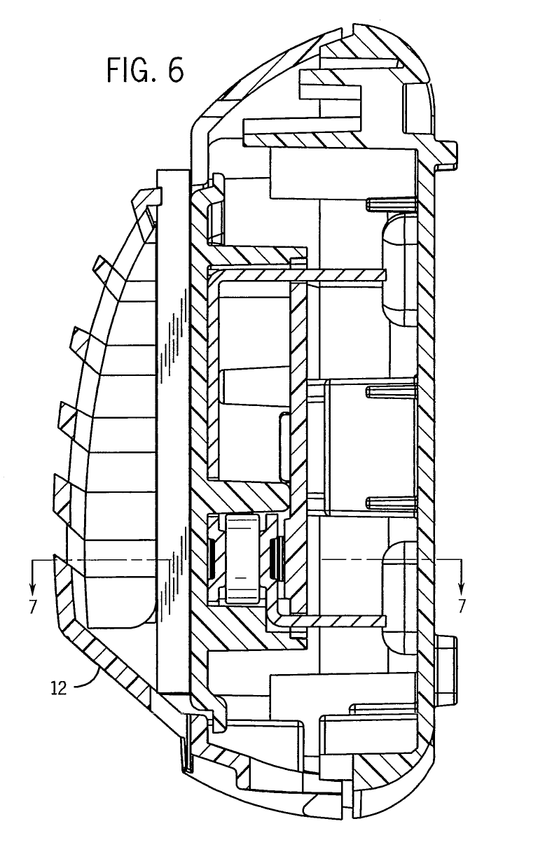

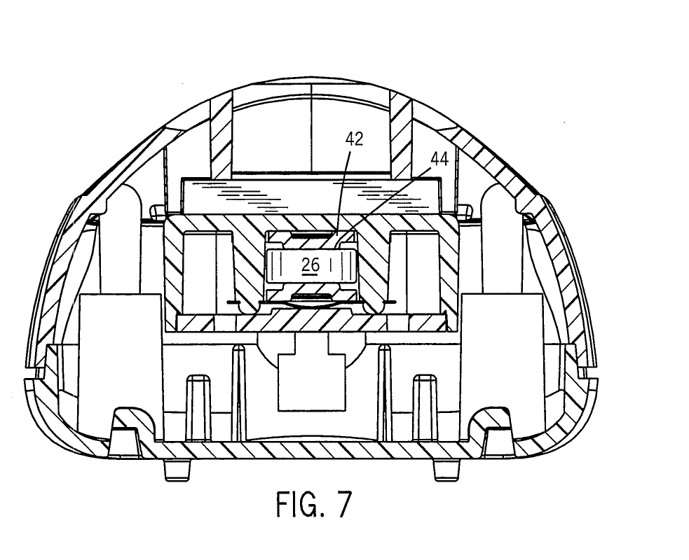

As seen in FIGS. 6 and 7, the heater 14 is, after final assembly enclosed by protective cover 12 and housing bottom 18 of the vaporizer 10. The mat 16 fits between that cover and outer surface 92.

While the present invention has been described with reference to a particular embodiment, various other embodiments are possible as well. For example, it is not essential that the heater be in pill form, or even be a PTC heater.

Thus, the claims should be looked to in order to judge the full scope of the invention.

### INDUSTRIAL APPLICABILITY

The present invention provides a heating device with an improved spring/electrical contact assembly to adjust for heat expansion.

What is claimed is:

1. A heating device, comprising:
a housing defining an internal cavity and having spaced supports extending there from into the cavity;
a heating element positioned in the cavity;
a first electrical contact abutting the heating element along a first side of the heating element;
a second electrical contact abutting the heating element at a location spaced from the first electrical contact; and
a spring suspended by the spaced supports and having a suspended portion thereof biased against the housing with a portion thereof biasing the second electrical contact towards the heating element.

2. The heating device of claim 1, wherein the heating element is a positive temperature coefficient heating element.

3. The heating device of claim 1, wherein the spring has a convex surface pointed away from the second electrical contact and is in contact with the housing.

4. The heating device of claim 3, wherein the spring also has a concave surface pointed towards the second electrical contact.

5. The heating device of claim 4, wherein the spring has both concave and convex portions.

6. The heating device of claim 4, wherein the first electrical contact has a contact head that bulges towards the heating element.

7. The heating device of claim 1, wherein the spaced supports are in a form of spaced pegs that are integral with the housing.

8. The heating device of claim 3, wherein, when the heating element is operational, the convex surface of the spring remains biased against the housing if the housing expands.

9. The heating device of claim 2, further comprising a substrate positioned against an outside surface of the housing, the substrate bearing an air treatment chemical.

10. The heating device of claim 9, wherein the substrate is a mat that is impregnated with an insect control agent that can volatize from the mat when the mat is heated by the heating device.
